(19) United States
(12) Patent Application Publication
(10) Pub. No.: US 2004/0266455 A1
(43) Pub. Date: Dec. 30, 2004

(54) Apparatus and method for searching location information using various location detection technology in a mobile communication terminal

(75) Inventors: Sang-man Lee, Osan-si (KR); Su-hyun Lee, Seoul (KR); Eun-young Choi, Seoul (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD.

(21) Appl. No.: 10/849,064

(22) Filed: May 20, 2004

(30) Foreign Application Priority Data
Jun. 24, 2003 (KR) 10-2003-0041107

(51) Int. Cl. H04Q 7/20

(52) U.S. Cl. 455/456.1; 455/456.2; 455/456.5

(57) ABSTRACT

An apparatus and method for searching for location information using various location detection technologies in a mobile communication terminal. The location information searching apparatus includes a location information searching unit and a location information processing unit. The location information searching unit requests a search for location information of the mobile communication terminal from an external location information server. The location information processing unit transfers the request for the search for the location information of the mobile communication terminal, which is made by an application, to the location information searching unit, and transmits searched location information, which is received from the location information searching unit, to the application.

### BACKGROUND OF THE INVENTION

This application claims the priority of Korean Patent Application No. 10-2003-0041107 filed on Jun. 24, 2003, in the Korean Intellectual Property Office, the disclosure of which is incorporated herein by reference.

1. Field of the Invention

The present invention relates generally to an apparatus and method for searching for location information using various location detection technologies in a mobile communication terminal and. More particularly, the invention relates to an apparatus and method of searching for location information using a mobile communication terminal, and converting the location information and some other information into a form supported by an application. The converted information is transmitted to the application, when the application of a mobile communication terminal requests the location information and some other information.

2. Description of the Related Art

FIG. 1 is a schematic diagram showing the configuration of a conventional apparatus for searching for location information. In order to obtain current location information after an application is executed, the conventional location information searching apparatus uses two methods as described below.

In accordance with the first method, when the application of a mobile communication terminal 10, which is capable of accessing the wireless Internet and downloading information therefrom, requests location information from a service provider 20 that provides Location-Based Services (LBS), the service provider 20 transfers the request of the application to a location information server 30.

Thereafter, the location information server 30 searches for the location information of the mobile communication terminal 10 and provides searched location information to the service provider 20, and the service provider 20 transmits the searched location information provided by the location information server 30 to the application of the mobile communication terminal 10.

This conventional method is disadvantageous in that the application of the mobile communication terminal 10 can not directly connect with the location information server 30 of the mobile communication service. Further, in the case where a method of searching for location information is changed, the service provider 20 must provide a new application corresponding to the changed location information searching method.

In accordance with the second conventional method, when the application requests a search for location information from the location information server 30 after the service provider 10 obtains the right to use the location information server 30 based on an agreement with a mobile communication service provider, the location information server 30 requests the calculation of a location from a location calculation server 40. The location calculation server 40 calculates the current location of the mobile communication terminal 10 while communicating with the mobile communication terminal 10 and, thereafter, transmits the values of the calculated current location to the location information server 30.

Accordingly, the location information server 30 notifies the mobile communication terminal 10 and the service provider 20 of the transmitted information. The service provider 20 transmits a map corresponding to the location information to the mobile communication terminal 10.

This second conventional method is advantageous in that the application of the mobile communication terminal 10 directly connects with the location information server 30 of the mobile communication service provider. However, this method is also inconvenient in that, in the case where the mobile communication service provider changes a method of searching for location information, the service provider 20 must provide a new application corresponding to the changed location information searching method of the mobile communication service provider.

### SUMMARY OF THE INVENTION

Accordingly, the present invention has been made keeping in mind the above problems occurring in the prior art, and an object of the present invention is to provide an apparatus and method for searching for location information using a mobile communication terminal. An interface is provided which is capable of converting location information and some other information, which are both obtained in response to the request of a certain application, into a form supported by the application. The converted location information is then transmitted to the application.

Another object of the present invention is to provide an apparatus and method for searching for location information using a mobile communication terminal, which provides an interface capable of being shared by a plurality of applications, so that an application can obtain corresponding information without changing an application, even in the case where a method of searching for the location information of a mobile communication terminal is changed.

In order to accomplish the above objects, the present invention provides an apparatus for searching for location information using a mobile communication terminal, including a location information searching unit for requesting a search for location information of the mobile communication terminal from an external location information server. Additionally, a location information processing unit is provided for transferring the requested search for the location information of the mobile communication terminal, which is made by an application, to the location information searching unit. Further, the searched location information, which is received from the location information searching unit, is transmitted to the application.

The present invention provides a method of searching for location information using a mobile communication terminal, including the steps of an application requesting location information of the mobile communication terminal from a location information processing unit, the location information processing unit transferring the request of the application to a location information searching unit, the location information searching unit requesting the search for the location information of the mobile communication terminal received from the location information processing unit, and the location information processing unit converting the location information, which is received from the location information searching unit, into a form supported by the application, and transmitting the converted location information to the application.

### BRIEF DESCRIPTION OF THE DRAWINGS

The above and other objects, features and other advantages of the present invention will be more clearly understood from the following detailed description taken in conjunction with the accompanying drawings, in which:

FIG. 1 is a schematic diagram showing the configuration of a conventional apparatus for searching for location information;

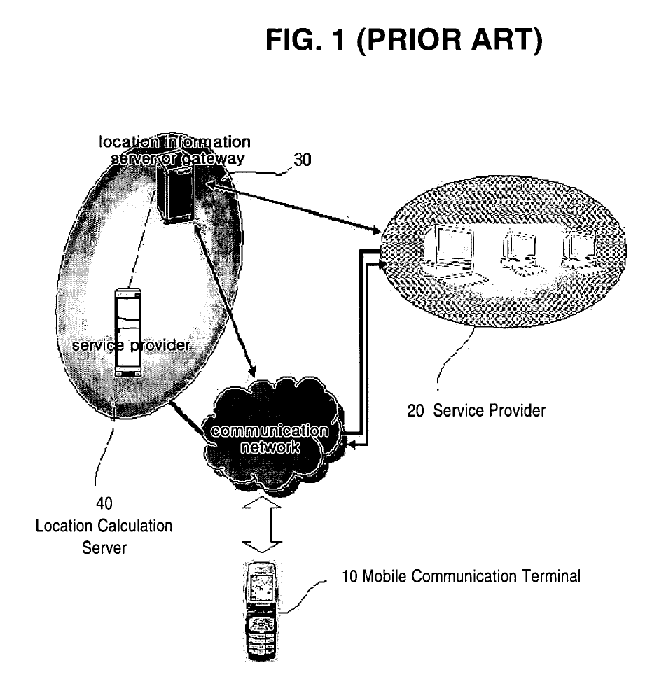

FIG. 2 is a block diagram schematically illustrating an apparatus for searching for location information using various location detection technologies in a mobile communication terminal in accordance with the present invention;

FIG. 3 is a flowchart showing a method of searching for location information using various location detection technologies in a mobile communication terminal; and

FIG. 4 is a schematic diagram showing the internal configuration of an apparatus for searching for location information using various location detection technologies in a mobile communication terminal in accordance with an embodiment of the present invention.

### DESCRIPTION OF THE PREFERRED EMBODIMENTS

Reference now should be made to the drawings, in which the same reference numerals are used throughout the different drawings to designate the same or similar components.

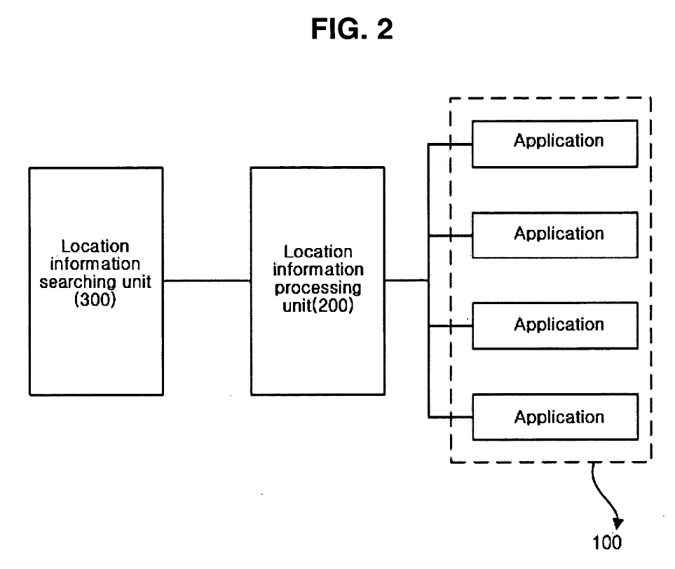

FIG. 2 is a block diagram schematically illustrating an apparatus for searching for location information using various location detection technologies in a mobile communication terminal in accordance with the present invention. The apparatus of FIG. 2 includes one or more applications 100, a location information processing unit 200 and a location information searching unit 300.

Each of the applications 100 performs a specific function according to specific settings. For example, one of the applications 100 requests a search for a location information service with respect to a specific location.

The location information processing unit 200 transfers the request for the search for the location information of a specific terminal, which is made by the application, to the location information searching unit 300, and transfers location information, which is received from the location information searching unit 300, to the application. In this case, the location information processing unit 200 converts the location information, which is received from the location information searching unit 300, into a form supported by the requesting application of applications 100, and transmits the converted location information to the requesting application.

The location information searching unit 300 requests a search for the location information of a specific mobile communication terminal from an external location information server (not shown), and includes a plurality of location searching modules for requesting and receiving location information and a LBS setting module for controlling the plurality of location searching modules. The location searching modules may be Data Burst Message (DBM) modules for providing location information using messages, wireless Internet modules for providing location information through wireless Internet accesses, or Global Positioning System (GPS) modules for providing location information by indicating the current locations of users and desired destinations on maps. The location information can be obtained using other types of location searching modules other than the above-described modules.

The LBS are services that combine the location of a mobile communication terminal with geographical information and peripheral information and provide the location of the mobile communication terminal together with the geographical information and the peripheral information. The LBS setting module stores information about the plurality of location searching modules and information about a location searching module set to a default. The LBS setting module can select one from the plurality of location searching modules and request a search for location information from the selected location searching module, or can request a search for location information from a location searching module designated by the application 100.

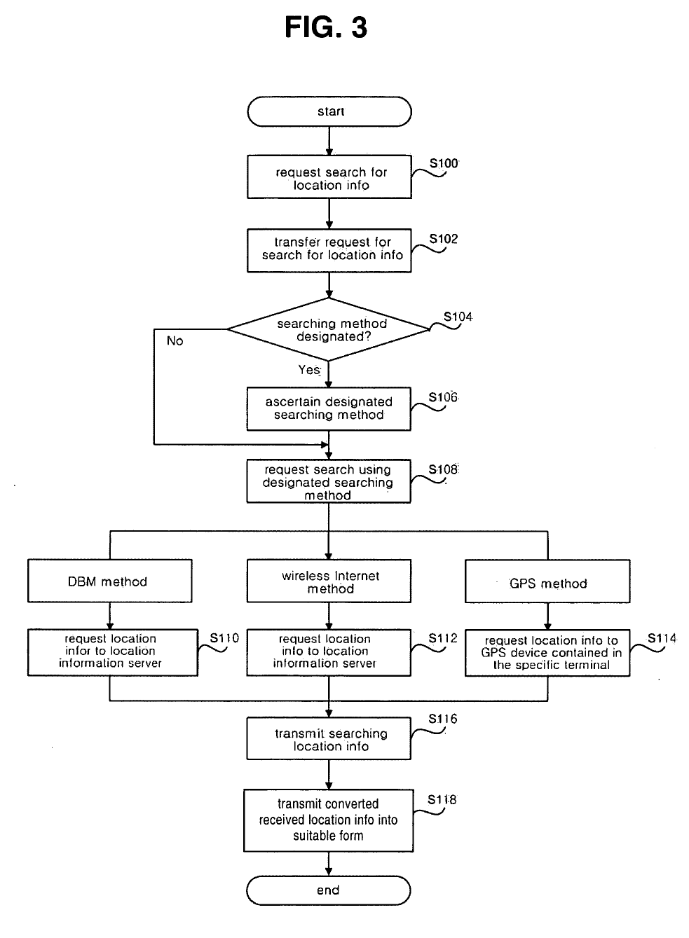

FIG. 3 is a flowchart showing a method of searching for location information using various location detection technologies in a mobile communication terminal. When application 100 requests the location information of a specific mobile communication terminal from the location information processing unit 200 at step S100, the location information processing unit 200 transfers the request of the application 100 to the location information searching unit 300 at step S102.

Thereafter, the location information searching unit 300 determines whether the location information processing unit 200 has designated a method of searching for the location information of the specific terminal when requesting the location information of the specific terminal at step S104.

If it is determined that the location information searching method has been designated, the LBS setting module ascertains the location information searching method at step S106, and requests the search for the location information of the specific terminal using the designated location information searching method from the external location information server at step S108. In this case, the location information searching method may be a DBM method, wireless Internet method or GPS method.

In the case where the designated location information searching method is the DBM method, the DBM module requests the search for the location information of the specific terminal from the external location information server using a DBM at step S110. The external location information server searches for the location information of the specific terminal and transmits location information searched for by the DBM method.

In the case where the designated location information searching method is the wireless Internet method, the wireless Internet module accesses the external location information server using the wireless Internet method and requests the search for the location information of the specific mobile communication terminal from the external location information server at step S112. The external location information server searches for the location information of the specific terminal and transmits searched location information to the wireless Internet module.

In the case where the designated location information searching method is the GPS method, the GPS module requests the search for the location information of the specific terminal from a GPS device contained in the specific terminal at step S 114. The GPS device searches for the location information of the specific terminal using a satellite and transmits searched location information to the GPS module.

Thereafter, the location searching unit 300 transmits the received location information of the specific terminal to the location information processing unit 200 at step S116. The location processing unit 200 converts the location information, which is received from the location information searching unit 300, into a form supported by the application 100, and transmits the converted location information to the application at step S118.

If it is determined that the location information searching method has not been designated, the LBS setting module requests the search for the location information of the specific terminal through a certain location searching module at step S108. In this case, the LBS setting module ascertains some of the plurality of location searching modules that can allow current location information to be obtained, and sets one of the location searching modules to a default. For example, the LBS setting module may request the search for the location information of the specific terminal from the location searching module corresponding to the method by which the specific terminal is currently provided with a location information service, or it may select one of the plurality of location searching modules and request the search for the location information of the specific terminal from the selected location searching module.

Thereafter, when the LBS setting module receives the request for the search of the location information, the LBS setting module requests the location information of the specific terminal from the location searching module set to the default. The location searching module set to the default may be changed to some other location searching module according to a change in the method of searching for the location information.

Thereafter, the steps S110 to S118 are performed in the same manner as described above.

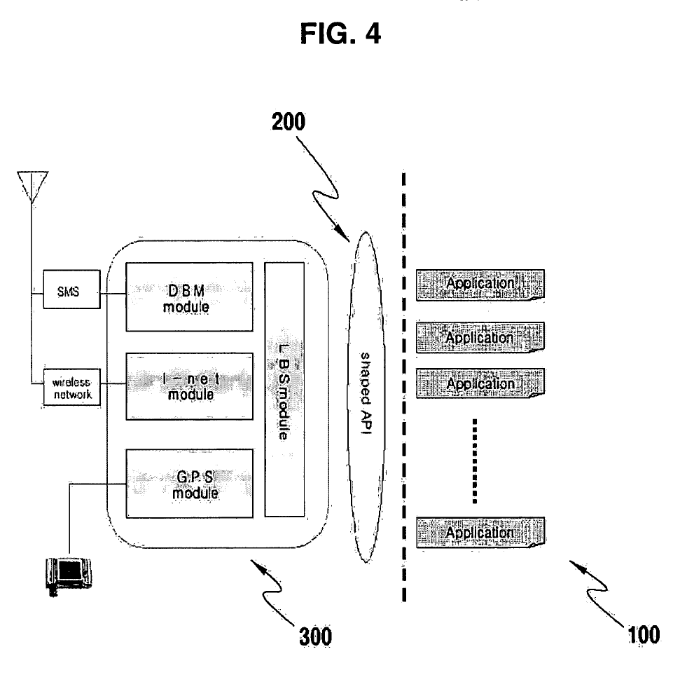

FIG. 4 is a schematic diagram showing the internal configuration of an apparatus for searching for location information using various location detection technologies in a mobile communication terminal in accordance with an embodiment of the present invention. When an application 100 requests location information of a specific communication terminal from a location information processing unit 200 (for example, a common Application Programming Interface (API)), the shared API transmits the request of the application 100 to the location information searching unit 300, and a LBS setting module selects one of a plurality of location searching modules and requests the location information of the specific terminal from the external location information server through the selected location searching module. In this case, the LBS setting module sets one of the plurality of location searching modules, which can currently search for the location information of the specific terminal, to a default, and requests the location information of the specific terminal from the location searching module. The plurality of location searching modules include at least DBM modules, wireless Internet modules and GPS modules.

For example, when a search for the location information of a specific terminal using the DBM method is requested, the LBS setting module requests the search for the location information of the specific terminal from the external location information server through the DBM module. The external location information server searches for the location information of the specific terminal, and transmits location information searched for by the DBM method to the DBM module.

When a search for the location information of a specific terminal using the wireless Internet method is requested, the LBS setting module requests the search for the location information of the specific terminal from the external location information server through the wireless Internet module. The external location information server searches for the location information of the specific terminal, and transmits location information searched for by the wireless Internet method to the DBM module.

When a search for the location information of the specific terminal using the GPS method is requested, the LBS setting module requests the search for the location information of the specific terminal from the GPS device positioned in the specific terminal through the GPS module. The GPS device searches for the location information of the specific terminal using a satellite, and transmits location information searched for by the GPS method to the GPS module.

Generally, when the application 100 requests a search for the location information of a specific terminal using a certain location searching method, the LBS setting module requests the search for the location information of the specific terminal using the certain location searching method.

Thereafter, the LBS setting module transmits received and searched location information to the shared API, and the shared API converts the location information, which is received from the LBS setting module, into a form supported by the application 100, and transmits the converted location information to the application 100.

With the above-described scheme, an application 100 can obtain desired information regardless of the methods of searching for the location information.

The present invention provides an interface capable of being shared by a plurality of applications, so that at least one of the applications can obtain relevant information without changing to a different application, even in the case where a method of searching for the location information of a mobile communication terminal is changed.

Additionally, in accordance with the present invention, location information is converted, as well as some other information, which are obtained in response to the request of a certain application. The information is converted into a form supported by the application, and transmitted to the application, so that the application can obtain relevant information.

Additionally, the application of a mobile communication terminal can obtain information required for location information services, so that the addition of equipment and functionality to a communication network is not necessary to support the location information services.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

What is claimed is:

1. An apparatus for searching for location information using various location detection technologies in a mobile communication terminal, the apparatus comprising:
a location information searching unit operable to request a search for location information of the mobile communication terminal from an external location information server wherein the request is generated within an application within the mobile communication terminal; and
a location information processing unit operable to transfer the request for the search for the location information of the mobile communication terminal, to the location information searching unit, and transmit received location information, which is received from the location information searching unit, to the application.

2. The apparatus as set forth in claim 1, wherein the location information searching unit comprises:
a plurality of location searching modules operable to request and receive the location information; and
a Location-Based Services (LBS) setting server operable to control the plurality of location searching modules.

3. The apparatus as set forth in claim 2, wherein the LBS server is operable to store information about the plurality of location searching modules and information about a location searching module currently set as a default, and further operable to select one of the plurality of location searching modules, and request the search for the location information from the location searching module.

4. The apparatus as set forth in claim 1, wherein the location information processing unit is operable to convert the location information, which is received from the location information searching unit, into a form supported by the application, and transmit the converted location information to the application.

5. A method of searching for location information of a mobile communication terminal using various location detection technologies, the method comprising:
an application requesting the location information of the mobile communication terminal from a location information processing unit;
the location information processing unit transferring the request of the application to a location information searching unit;
the location information searching unit requesting the search for the location information of the mobile communication terminal received from the location information processing unit; and
the location information processing unit converting the location information, which is received from the location information searching unit, into a form supported by the application, and transmitting the converted location information to the application.

6. The method as set forth in claim 5, wherein the step of the application requesting the location information of the mobile communication terminal from the location information processing unit comprises:
the application designating a method of searching for the location information of the mobile communication terminal and requesting the search for the location information of the mobile communication terminal from an interface; and
the application transferring the method of searching for the location information of the mobile communication terminal to the location information searching unit.

7. The method as set forth in claim 5, wherein the step of the location information searching unit requesting the search for the location information of the mobile communication terminal received from the location information processing unit further comprises the location information searching unit selecting one of a plurality of location searching modules and requesting the search for the location information of the mobile communication terminal from the selected location searching module.

8. The method as set forth in claim 7, wherein the selected location searching module is a module for requesting and receiving the location information of the mobile communication terminal using a Data Burst Message (DBM) method.

9. The method as set forth in claim 7, wherein the selected location searching module is a module for requesting and receiving the location information of the mobile communication terminal using a wireless Internet method.

10. The method as set forth in claim 7, wherein the selected location searching module is a module for requesting and receiving the location information of the mobile communication terminal using a Global Positioning System (GPS) method.
